(19) United States
(12) Patent Application Publication
(10) Pub. No.: US 2005/0076893 A1
(43) Pub. Date: Apr. 14, 2005

(54) Electronic timing system of automobile engine

(76) Inventor: Jingfeng Guan, Seattle, WA (US)

Correspondence Address: Jingfeng Guan, 6323 65th AVE NE, #4701, Seattle, WA, 98115, US

(21) Appl. No.: 10/681,551

(22) Filed: Oct. 9, 2003

(51) Int. Cl. F02P 5/00; F01L 9/04

(52) U.S. Cl. 123/618; 123/90.11

(57) ABSTRACT

An electronic timing system, a substitution of traditional timing belt and the mechanical parts relating to timing belt, and of the type can control correct timing of automobile engine. It helps to design smaller and efficient engine, save energy cost and save possible labor cost to replace timing belt.

### BACKGROUND

1. Field of Invention

This invention relates to automobile engine timing.

2. Description of Prior Art

Usually, an automobile engine comprises a timing belt to control the time of igniting, intaking and exhausting gas. Nowadays, some models of automobiles require the replacement of timing belts after 50,000 or 60,000 miles, some models can last longer.

There are several disadvantages of timing belt:
(a) If an automobile's timing belt fails for some reasons, such as broken, the automobile has to replace the timing belt, which costs a lot for labor fee.

(b) An automobile's timing needs to be tuned after a period of time for timing correction. Otherwise, the automobile's engine won't be able to operate efficiently, which could increases gas cost greatly.

### OBJECTS AND ADVANTAGE

Accordingly, there are several objects and advantages of the present invention:
(a) Electronic timing system can be replaced easily;
(b) Electronic timing system can control the engine actions, such as igniting, intaking, and exhausting, at the right time with the help of senser chip (such as MC33794). This feature will help an automobile engine with electronic timing system to operate in the most efficient state.

(c) The engine with electronic timing system doesn't need the mechanical parts associated with timing belt, such as camshaft. The electronic timing system tells the engine cylinders when to intake, when to ignite and when to exhasust. This feature helps to design a smaller and more efficient engine. It also gives more freedom and/or space for the engine design.

### SUMMARY OF THE INVENTION

In accordance with the present invention an electronic timing system of automobile engine, a substitution of traditional timing belt, comprises two electrodes installed in one cylinder or each two electrodes installed in each cylinder, a Motorola e-field senser chip MC33794 (for engine of 4 cylinders or less, 2 senser chips for engine of 8 cylinders or less, etc.), and a microcontroller chip (working with one e-field senser chip, two controllers for two e-field senser chips, etc.).

### DESCRIPTION OF DRAWING FIGURES

There are totally 7 drawings in this application.

FIG. 1 shows a typical cylinder of an engine. The engine may have several cylinders, such as 4 cylinders, 6 cylinders and 8 cylinders.

FIG. 2 shows the upper position of the piston of the engine and electrode A1. The electrode A1 is covered by the piston only when the piston reaches the highest position in the cylinder. The actual position of the electrode A1 may be different from different engines. Here is only an example.

FIG. 3 shows the lower position of the piston of the engine and electrode B1. The electrode B1 is covered by the piston only when the piston reaches the lowest position in the cylinder. The actual position of the electrode B1 may be different from different engines. Here is only an example.

FIG. 4 shows the side of the piston against the electrode B1. The window at the bottom of this figure may be required to make sure that the electrode B1 is covered by the piston only when the piston reaches the lowest position. The actual size of the window may be different. Here is only an example.

FIG. 5 shows the diagram of the micro controller and Motorola MC33794 e-field chip.

FIG. 6 shows an example how the states of electrodes control the timing of intaking, igniting and exhausting of an automobile engine.

FIG. 7 shows the electrode-select of each electrode in MC33794.

### REFERENCE NUMBERS IN THE DRAWINGS

1. Intake valve
2. Exhaust valve
3. Spark plug
4. Piston
5. Electrode A1
6. Electrode B1
7. Electrode A2
8. Electrode B2
9. Electrode A3
10. Electrode B3
11. Electrode A4
12. Electrode B4
13. Micro controller
14. Motorola MC33794
15. Electrode selection bits (A B C D) in MC33794

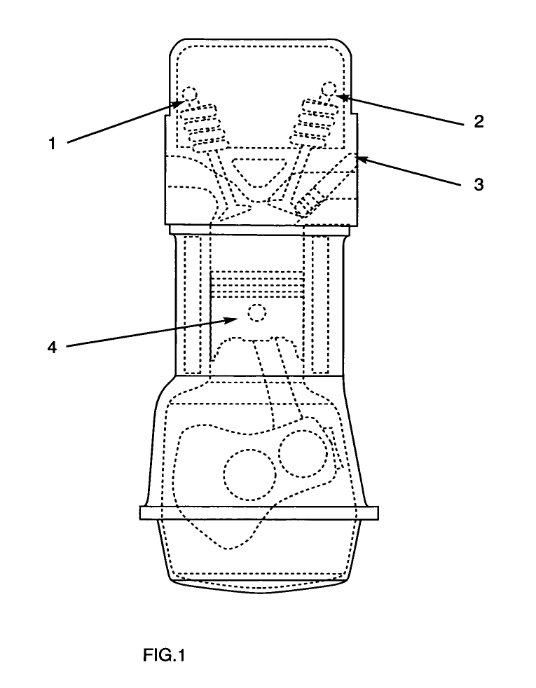

### DETAIL DESCRIPTION OF THE INVENTION—FIGS. 1 TO 7

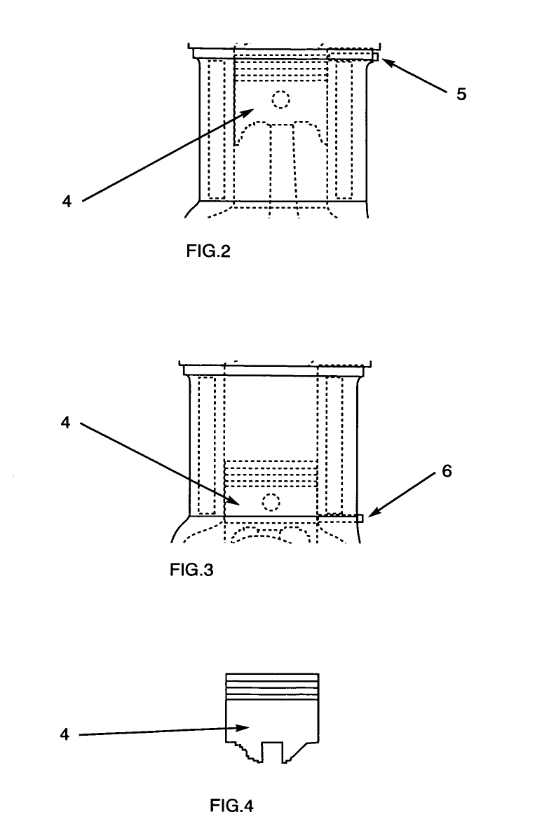

There are several types of car engines. A typical 4-stroke 4-cylinder engine is described here as an example. A typical engine cylinder is shown in FIG. 1. It consists of an intake valve 1, an exhaust valve 2, a spark plug 3, a piston 4 and some other parts which are not illustrated. In a 4-stroke engine, the piston begins on the top position as shown in FIG. 2, it moves down to lowest positoin as shown in FIG. 3 in Intake stroke, while the intake valve is open and the exhaust valve is close; then the piston moves up to the highest positon as shown in FIG. 2 to compress oil and air mixture in Compression stroke, while both intake valve and exhaust valve are close; just after that while the piston is at the highest position, the spark plug starts a spark to explode the oil/air mixture, which drives the piston down to the lowest position; when the piston reaches the lowest position, the piston moves up to the highest positon while the exhaust valve is open to get rid of exhaust gas out.

In this invention, one engine cylinder is installed with two electrodes or each engine cylinder is installed with two electrodes. In cylinder one, electrode A1 5 is installed at the highest position the piston 4 can reach as shown in FIG. 2 and electrode B1 6 is installed at the lowest postion the piston 4 can reach as shown in FIG. 3. The electrode A1 5 is connected to E1 in MC33794 and the electrode B1 6 is connected to E2 in MC33794. Since the piston 4 may already cover the electrode B1 6 before it reaches the lowest postion, a window as shown in FIG. 4 may be necessary for the correction. The signals of the two electrodes 5 6 change when the piston 4 reaches them. The signal can be calibrated with the two reference electrodes (REF_A and REF_B) in MC33794 14. These two reference electrodes can set the lowest signal and highest signal an actual system can cover and the system could assign the lowest value as 0 and the highest signal as a number, such as 256 for 8-bit. Then the signal from each electrode can be compared with the two reference signals and find the value of the signal, which is a number between 0 and 256.

A micro controller 13 scans the signals from electrode A1 5 and electrode B1 6. If a signal from an electrode is smaller than a threshold value, this signal is treated as nothing; if a signal is bigger than the threshold value, that signal is treated as a trigger so that the state of that electrode changes from 0 to 1 or from 1 to 0. The micro controller 13 scans these electrodes and update the states of them in real time. The threshold is selected by measurement in actual conditions since this value would change when conditions change. Since the signal from an electrode is bigger when the piston 4 cover it and the signal is smaller when the piston 4 is away from it, the threshold can be found easily.

The states of A1 5 and B1 6 are either 0 or 1. The states of A1 and B1 are set to 0 and 1 respectively in the start. In the intake stroke, the state of A1 starts at 0 and the state of B1 starts at 1; when the piston 4 reaches the lowest pisition, the state of B1 changes to 0 while the state of A1 is still 0. In the compression stroke, the state of A1 starts at 0 and the state of B1 starts at 0; when the piston reaches the highest position, the state of A1 changes to 1 while the state of B1 is still 0. In the combustion stroke, the state of A1 starts at 1 and the state of B1 starts at 0; the spark plug ignites the oil/air mixture just at the start of the stroke and drives the piston down; when the piston reaches the lowest position, the state of B1 changes to 1 while the state of A1 is still 1. In the exhaust stroke, the state of A1 starts at 1 and the state of B1 starts at 1; when the piston reaches the highest position, the state of A1 changes to 0 and the state of B1 is still 1. After one 4-stroke cycle, the states of A1 and B1 change back to the starting states, 0 and 1 respectively.

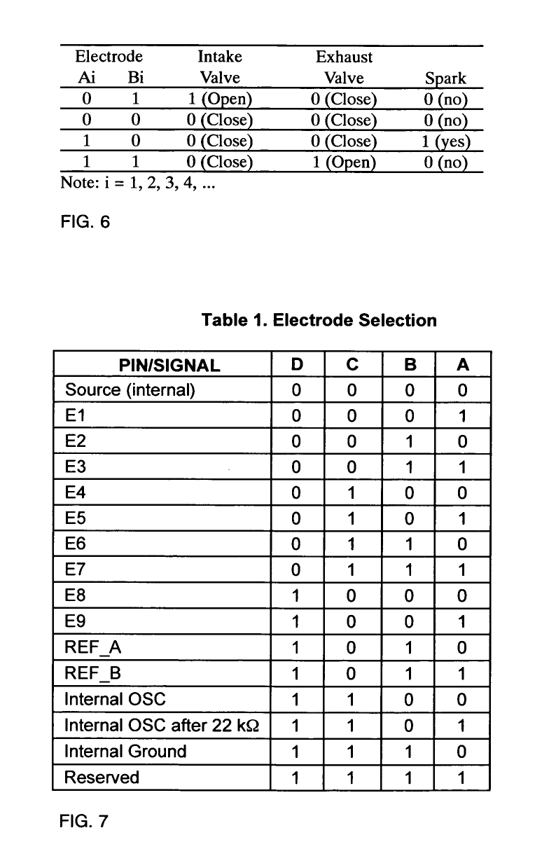

The opening and closing of intake valve 1, exhaust valve 2 and igniting spark 3 are controlled by the states of electrode A1 5 and B1 6. As shown in FIG. 6, when the state of A1 is 0 and the state of B1 is 1, the state of intake valve 1 is set to 1 to signal the opening of the intake valve 1, the state of exhaust valve 2 is set to 0 to signal the closing of the exhaust valve 2 and the state of spark 3 is set to 0 to signal the no-igniting of the spark 3. When the state of A1 is 0 and the state of B1 is 0, the state of intake valve 1 is set to 0 to signal the closing of the intake valve 1, the state of exhaust valve 2 is set to 0 to signal the closing of the exhaust valve 2 and the state of spark 3 is set to 0 to signal the no-igniting of the spark 3. When the state of A1 is 1 and the state of B1 is 0, the state of intake valve 1 is set to 0 to signal the closing of the intake valve 1, the state of exhaust valve 2 is set to 0 to signal the closing of the exhaust valve 2 and the state of spark 3 is set to 1 to signal the igniting of the spark 3. When the state of A1 is 1 and the state of B1 is 1, the state of intake valve 1 is set to 0 to signal the closing of the intake valve 1, the state of exhaust valve 2 is set to 1 to signal the opening of the exhaust valve 2 and the state of spark 3 is set to 0 to signal the no-igniting of the spark 3. By monitoring the states of the electrode A1 5 and the electrode B1 6, the correct timing for opening intake valve 1, opening of exhaust valve 2 and igniting spark 3 can be achived.

The igniting of the spark 3 lasts very short time, depending on the design of the spark 3. Each time when the state of spark 3 changes from 0 to 1, the spark 3 ignites for the short period of time and then stop. The spark 3 will ignite again when the state of spark 3 changes from 0 to 1 again at next cycle.

The 4 pistons of the 4 cylinders of a 4-cylinder engine can be set in phase during the 4-stroke cycle. The term “in phase” means that when one piston in a cylinder is at the moment of starting a stroke, all other cylinders are at the moment of starting one of the strokes. For example, when the piston of the first cylinder is at the moment of starting intake stroke, the piston of the second cylinder is just at the start of compression stroke, the piston of the third cylinder is just at the start of combustion stroke, and the piston of the fourth cylinder is just at the start of exhaust stroke. In this case, only one cylinder is required to install the electrodes, which means two electrodes are enough for a 4-cylinder engine.

If the pistons of the 4 cylinders of a 4-cylinder engine are not in phase, the electrode A1 and electrode B1 are installed to the first cylinder, the electrode A2 7 and the electrode B2 8 are installed to the second cylinder, the electrode A3 9 and electrode B3 10 are installed to the third cylinder and the electrode A4 11 and the electrode B4 12 are installed to the fourth cylinder. The starting states of electrode A2, B2, A3, B3, A4 and B4 may be different from the electrode A1 5 and the electrode B1 6.

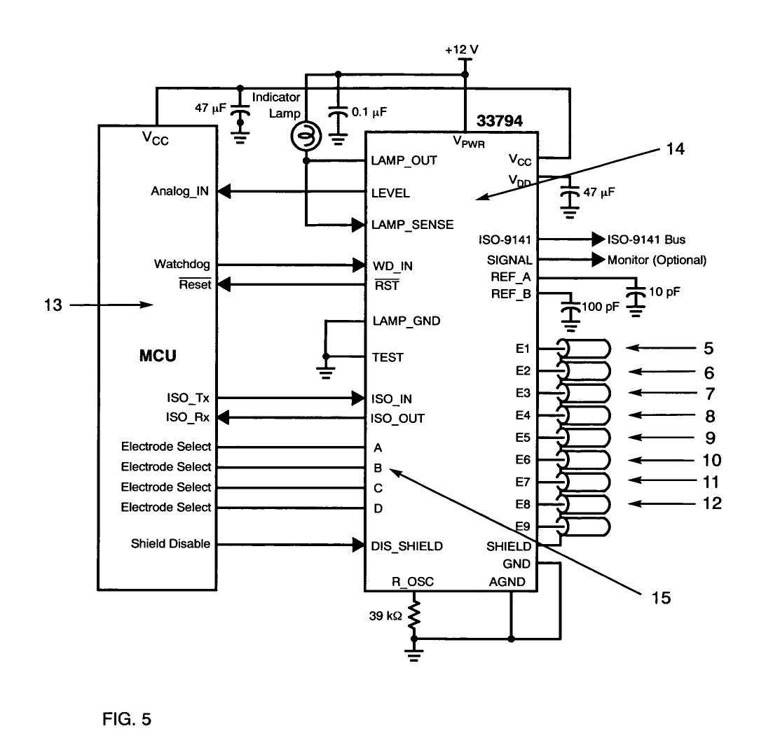

One MC33794 chip can support 9 electrodes, E1 to E9. For the engine of 4 cylinders, if only one cylinder is installed with two electrodes, E1 is connected to the electrode A1 5, E2 is connected to the electrode B1 6. If each cylinder is installed with two electrodes, E1 is connected to the electrode A1 5, E2 is connected to the electrode B1 6, E3 is connected to the electrode A2 7, E4 is connected to the electrode B2 8; E5 is connected to the electrode A3 9, E6 is connected to the electrode B3 10; E7 is connected to the electrode A4 11, E8 is connected to the electrode B4 12, as shown in FIG. 5. For an engine of 6 or 8 cylinders, two MC33794 chips are required. The reference electrodes REF_A is pre-determined to connect a capacitor so that the signal from the electrode REF_A matches the largest signal one specific application can reach. The signal from the electrode REF_A represents the top signal level, such as 256 (for 8-bit). The reference electrodes REF_B is also pre-determined to connect a capacitor so that the signal from the electrode REF_B matches the smallest signal that specific application can reach. The signal from the electrode REF_B represents the bottom signal level, such as 0. Any signal that falls in between will be scaled to a number between 0 and 256.

The MC33794 can only read signal from one electrode at a time. The selection of each electrode is controlled by the 4 selection bit A, B, C and D 15, as shown in FIG. 5. The MCU 13 controls the selection and can be programmed. The lookup table for the selection of each electrode is illustrated in FIG. 7.

Since the programming codes may be different to different MCUs, the actual program to each specific MCU can be written based on the following description.

In the case that only one cylinder is installed with two electrodes, the MCU 13 initializes at the start of the automobile. First, it sets the states of two electrodes A1 and B1 to 0 and 1 respectively. Second, since the MC33794's clock is set to be 120 kHz (changable from external setting), and the MC33794 is set to scan signal from one of the electrodes at 1000 hz, one timer (timer1) is set to 120 and start this timer. Third, it sets the electrode-select [DCBA] to be [1010], preparing for scanning signal from the electrode REF_A. When the timer1 is time-out, it triggers to scan signal from the electrode REF_A and this timer resets and starts again. Fourth, it sets the electrode-select [DCBA] to be [1011], preparing for scanning signal from the electrode REF_B. When the timer1 is time-out, it triggers to scan signal from the electrode REF_B and this timer resets and starts again.

After the initialization, the MCU 13 sets the electrode-select [DCBA] to be [0010], preparing to scan the signal from the electrode B1 6. The first cylinder starts the intake stroke and this cylinder's intake valve opens, the second cylinder starts the compression stroke, the third cylinder starts the combustion stroke and this cylinder's spark ignites, and the fourth cylinder starts the exhaust stroke and this cylinder's exhaust valve opens. When the timer1 is time-out, the electrode B1 6 is scanned. If the signal from this electrode is lower than the threshold, there is no change of states of the elctrode A1 5 and the electrode B1 6. There is also no change to the electrode-select, so that the MCU 13 will scan the signal from the electrode B1 6 when the timer1 is time-out again. When the signal from the electrode B1 6 is bigger than the threshold, which means the piston 4 reaches the lowest position, the state of the electrode B1 6 changes to 0. After that, the MCU 13 sets the electrode-select [DCBA] to be [0001], preparing to scan the signal from the electrode A1 5. Now the first cylinder starts the compression stroke, the second cylinder starts the combustion stroke and this cylinder's spark ignites, the third cylinder starts the exhaust stroke and this cylinder's exhaust valve opens, and the fourth cylinder starts the intake stroke and this cylinder's intake valve opens. When the signal from the electrode A1 5 is bigger than the threshold, which means the piston 4 reaches the highest position, the state of the electrode A1 5 changes to 1. After that, the MCU 13 sets the electrode-select [DCBA] to be [0010], preparing to scan the signal from the electrode B1 6. And each cylinder starts the following stroke correspondingly.

The rule for the change of electrode-select is that: if the electrode B1 6 is reached, the next electrode-select [DCBA] will be [DCBA]−[0001], in this case it is [0010]−[0001]=[0001]; if the electrode A1 5 is reached, the next electrode-select [DCBA] will be [DCBA]+[0001]. This rule will make sure that after the electrode B1 6 is reached, the MCU 13 will change to scan the signal from the electrode A1 5 since the electrode A1 5 is expected next; meanwhile, after the electrode A1 5 is reached, the MCU 13 will change to scan the signal from the electrode B1 6 since the electrode B1 6 is expected next.

For the case that each cylinder is installed with two electrodes, the MCU 13 initializes at the start of the automobile. First, it sets the states of the electrodes A1 and B1 to 0 and 1, the states of the electrodes A2 and B2 to 0 and 0, the states of the electrodes A3 and B3 to 1 and 0, the states of the electrodes A4 and B4 to 1 and 1 respectively. Second, since the MC33794's clock is set to be 120 kHz (changable from external setting), and the MC33794 is set to scan signal from one of the electrodes at 4000 hz (so that each cylinder is scanned at 1000 hz), one timer (timer1) is set to be 30 and start this timer. Third, it sets the electrode-select [DCBA] to be [1010], preparing for scanning signal from the electrode REF_A. When the timer1 is time-out, it triggers to scan signal from the electrode REF_A and this timer resets and starts again. Fourth, it sets the electrode-select [DCBA] to be [1011], preparing for scanning signal from the electrode REF_B. When the timer1 is time-out, it triggers to scan signal from the electrode REF_B and this timer resets and starts again. Fifth, it sets the electrode-select [DCBA] to be [0010] (the electrode B1 6), and sets a buffer to contain the next three electrode-select [DCBA] to be [0011] (the electrode A2 7), [0110] (the electrode B3 10) and [0111] (the electrode A4 11) in consequence.

The rule for the change of electrode-select is that: if the electrode B1 (i=1, 2, 3 or 4) is reached, the next electrode-select [DCBA] to be put into the back of the buffer will be [DCBA]−[0001]; if the electrode A1 (i=1, 2, 3 or 4) is reached, the next electrode-select [DCBA] to be put into the back of the buffer will be [DCBA]+[0001]. This rule will make sure that after the electrode B1 is reached, the MCU 13 will put the electrode-select of the electrode A1 in the same cylinder into the buffer since the electrode A1 is expected; meanwhile, after the electrode A1 is reached, the MCU 13 will put the electrode-select of the electrode of the electrode B1 in the same cylinder into the buffer since the electrode B1 is expected.

After the initialization, The first cylinder starts the intake stroke and this cylinder's intake valve opens, the second cylinder starts the compression stroke, the third cylinder starts the combustion stroke and this cylinder's spark ignites, and the fourth cylinder starts the exhaust stroke and this cylinder's exhaust valve opens. when the timer1 is time-out, the MCU 13 scans the signal from the electrode B1 6 ([0010]). If the signal is lower than the threshold, there is no change to the state of the electrode B1 6. The MCU 13 sets the electrode-select [DCBA] to be [0011] and put the just scanned [0010] to the back of the buffer, so that the next scanned electrode will be electrode A2 7 ([0011]) and in the buffer are [0110] (the electrode B3 10), [0111] (the electrode A4 11) and [0010] (the electrode B1 6). If the signal is higher than the threshold, there is a change to the state of the electrode B1 6 from 1 to 0. The first cylinder starts the compression stroke. Then the MCU 13 sets the electrode-select [DCBA] to be [0011] (the electrode A2 7), changes the just scanned [0010] to [0001] ([0010]−[0001]) and puts it to the back of the buffer, so that the next scanned electrode will be the electrode A2 7 ([0011]) and in the buffer are [0110] (the electrode B3 10), [0111] (the electrode A4 11) and [0001] (the electrode A1 5).

If higher scanning frequency is required, there are several options. First, since the MC33794 clock is changable, the clock frequency can be set higher than current 120 kHz by changing the externl resistor; second, more than one MC33794 can be installed; third, shorter timer can be used. What are described here is just an example.

### SUMMARY

Accordingly, the reader will see that the use of sensors in an automobile engine to control timing in this invention is very attractive. It can be implemented in the automobile design very easily and conveniently. In addition, this invention has some advantages in that:
1. It solves the problem that impacts the automobile engine design due to the requirement of timing belt connections and helps to design smaller and more efficient engines.
2. It saves the labor cost to replace timing belt, since the electronic timing system can be replaced easily.
3. It will help engines to work in correct timing and save gas cost.

Although the description above contains many specificities, these should not be construed as limiting the scope of the invention but merely providing illustrations of some of the presently preferred embodiments of this invention. For example, the MC33794 can be set to scan signal from one of the electrodes at 1200 hz.

Thus the scope of the invention should be determined by the appended claims and their legal equivalents, rather than by the examples given.

1. In an Electronic Timing System of Automobile Engine of the type comprising one or more sensor chips (such as MC33794 from Motorola), one MCU (or more MCUs if more sensor chips are used) and electrodes that are installed in one or all of cylinders of said automobile engine, the said system provides means to control the timing of said automobile engine.

2. The system of claim 1 wherein an electrode is installed in a cylinder at the highest position that a piston of said cylinder can reach.

3. The system of claim 1 wherein an electrode is installed in said cylinder at the lowest position that said piston of said cylinder can reach.

4. The system of claim 1 wherein the state of said electrode installed in said cylinder at the highest position that said piston of said cylinder can reach and the state of said sensor electrode installed in said cylinder at the lowest position that said piston of said cylinder can reach form the timing control to said automobile engine.

5. The system of claim 4 wherein said states of said electrodes of said cylinder are initialized to be at intake stroke.

6. The system of claim 4 wherein said MCU chooses to scan signal from the other said electrode after one said electrode in said cylinder is reached by said piston.

7. The system of claim 4 wherein said state of said electrode installed in said cylinder at the highest position that said piston of said cylinder can reach changes from 0 to 1 or from 1 to 0 after that said electrode is reached.

8. The system of claim 4 wherein said state of said electrode installed in said cylinder at the lowest position that said piston of said cylinder can reach changes from 0 to 1 or from 1 to 0 after that said electrode is reached.

9. The system of claim 4 wherein other cylinders of said automobile engine are initiliazed to be at one of the engine strokes. The said other cylinders change to the next engine stroke when said cylinder installed with two electrodes changes engine stroke.

10. The system of claim 1 wherein each cylinder of said automobile engine can be installed with two electrodes as said cylinder.

11. The system of claim 10 wherein said states of said two electrodes installed in said each cylinder of said automobile engine are initialized to be at one of said engine stroke.

12. The system of claim 10 wherein said MCU sets a buffer containing electrode-selects of electrodes to be scanned.

13. The system of claim 12 wherein said buffer's size is determined by the number of said cylinders of said automobile engine. The said each cylinder of said automobile engine will have one said electrode's elctrode-select in said buffer or ready for scanning.
